(19) United States
(12) Patent Application Publication
(10) Pub. No.: US 2007/0268188 A1
(43) Pub. Date: Nov. 22, 2007

(54) GROUND PLANE PATCH ANTENNA

(75) Inventors: Debatosh Guha, Kolkata (IN); Yahia Mohamed Mostafa Antar, Kingston (CA); Joseph Fernand Paul Beland, Gatineau (CA)

Correspondence Address: PEARNE & GORDON LLP, 1801 EAST 9TH STREET, SUITE 1200, CLEVELAND, OH, 44114-3108, US

(73) Assignee: SPOTWAVE WIRELESS CANADA, INC., Kanata (CA)

(21) Appl. No.: 11/740,517

(22) Filed: Apr. 26, 2007

Related U.S. Application Data
(60) Provisional application No. 60/745,696, filed on Apr. 26, 2006.

(51) Int. Cl. H01Q 1/38

(52) U.S. Cl. 343/700 MS

(57) ABSTRACT

A patch antenna includes a ground plane surrounded by a wall defining a cavity. A radiating element is disposed within the cavity substantially parallel to the ground plane and separated from the ground plane by a composite dielectric including an air gap. An excitation probe is electrically connected to the radiating element for exciting at least a dominant mode of the radiating element. The radiating element includes an annular slot surrounding the excitation probe and defining a capacitive load for compensating an inductance of the excitation probe.

### CROSS-REFERENCE TO RELATED APPLICATIONS

This is the first application filed for the present invention.

### MICROFICHE APPENDIX

Not Applicable.

### TECHNICAL FIELD

The present application relates in general to wireless communications and, in particular, to an improved ground plane patch antenna.

### BACKGROUND OF THE INVENTION

A conventional microstrip patch with grounded substrate is a low profile radiating structure suitable for mobile communication systems. When excited by a Coaxial probe and resonating in the dominant mode, it radiates in its broadside direction. The inherent limitation of such a microstrip antenna is its narrow impedance bandwidth (2-3%) and limited gain (5-6 dBi). In addition, the ground plane must be quite large (≧3-4λ₀) to achieve smooth radiation characteristics.

Several applications in communications require antennas with significantly higher bandwidth. For example, to cover the North American PCS band (1850-1990 MHz) requires an antenna with a bandwidth of nearly 8%. Improved gain and small size are also required in many applications, such as in-building repeaters.

In addition, it is well known that different networks utilize different portions of the RF spectrum. For example, both the 824-894 MHz and 1850-1990 MHz frequency bands are commonly used in North America. In order to support wireless devices that access different networks, users are frequently compelled to install respective different antennas, and this tends to increase costs.

An improved ground plane patch antenna that overcomes at least some of these problems is highly desirable

### SUMMARY OF THE INVENTION

The present invention provides an improved ground plane patch antenna which provides a much greater bandwidth with higher gain (12 dBi) than a conventional ground plane patch, while using very limited ground plane (diameter≈1.0λ₀) size. This performance has been obtained through a combination of three improvements to the conventional antenna. These involve modifications to the element, feed structure and ground plane, and are described in more detail below.

The present application provides an Improved Ground Plane Patch Antenna (IGPPA) in which the radiation characteristics of a conventional ground plane patch antenna are substantially improved by using a combination of cavity backing, an air gap and a annular slot feed structure. The design principals for this new antenna are described below. This design is applicable to a wide range of frequency bands and applications.

### BRIEF DESCRIPTION OF THE DRAWINGS

Further features and advantages of the present invention will become apparent from the following detailed description, taken in combination with the appended drawings, in which:

FIG. 1 is a front view of a patch antenna in accordance with an embodiment of the present invention;

FIG. 2 is a cross-sectional view of the patch antenna of FIG. 1;

FIG. 3 shows the simulated and measured return loss of the antenna of FIG. 1 over a frequency range of interest;

FIG. 4 shows representative E-plane patterns of the antenna of FIG. 1;

FIG. 5 shows a patch antenna in accordance with a second embodiment of the present invention;

FIG. 6 shows a dual band patch antenna in accordance with a third embodiment of the present invention;

FIGS. 7a and 7b are cross sectional views showing respective variants of the of the patch antenna of FIG. 6;

FIG. 8 shows measured return loss of an antenna constructed in accordance with the embodiment of FIG. 6 over a frequency range of interest; and

FIG. 9 shows representative E-plane patterns of the antenna of FIG. 8.

It will be noted that throughout the appended drawings, like features are identified by like reference numerals.

### DETAILED DESCRIPTION OF THE PREFERRED EMBODIMENT

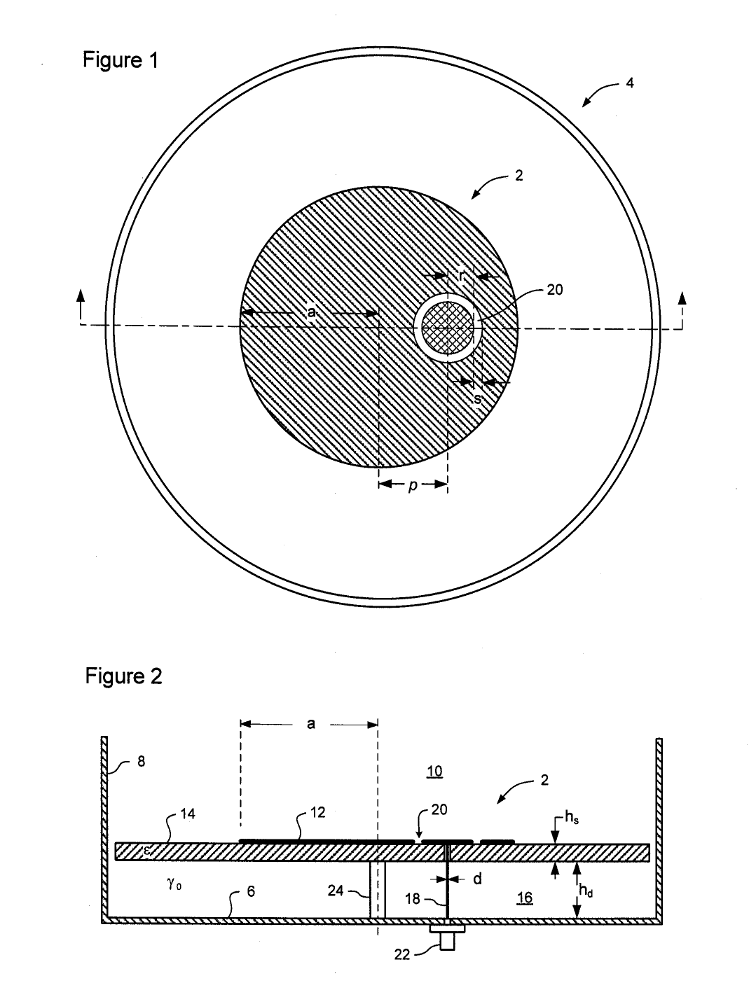

The present invention provides a ground plane patch antenna having a smaller ground plane and improved bandwidth. Representative embodiments of the patch antenna are described below with reference to FIGS. 1-9.

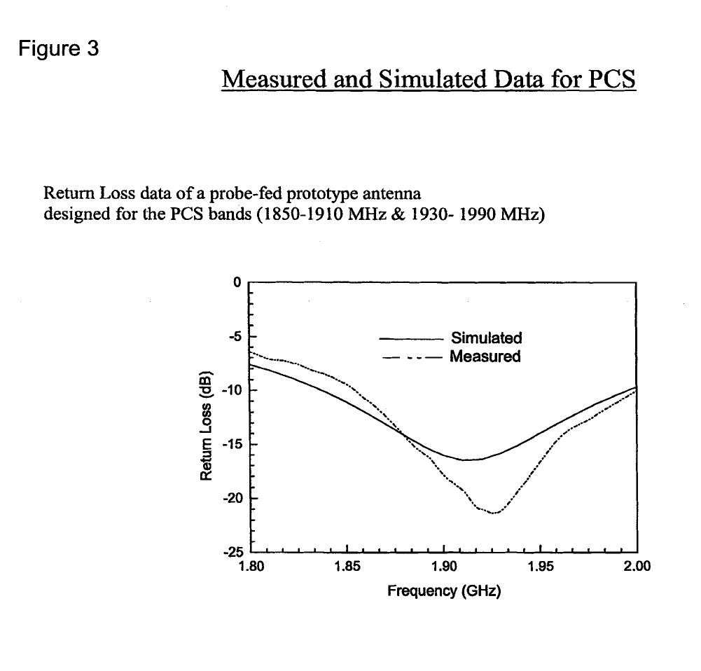

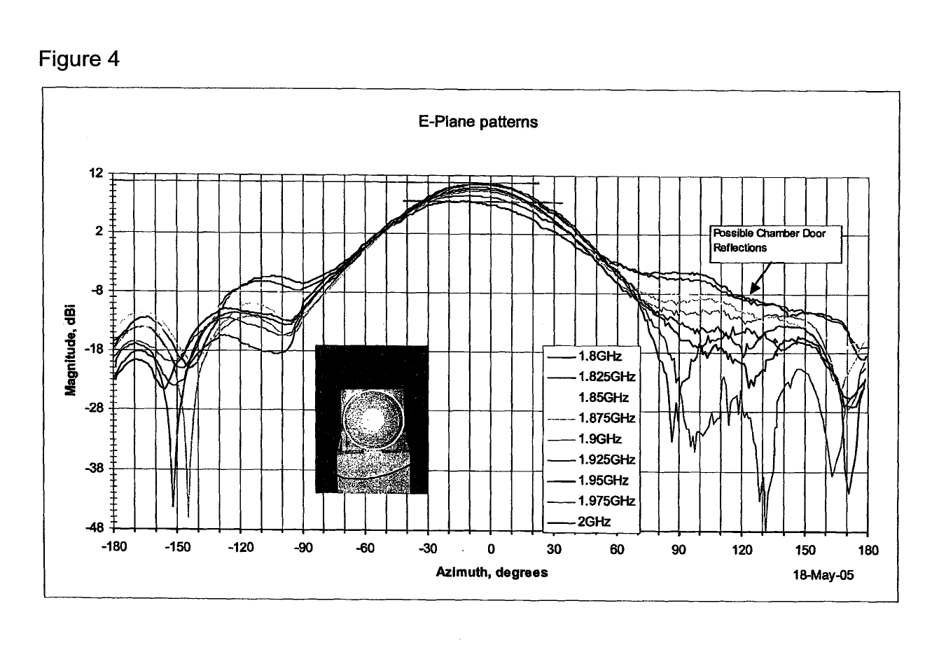

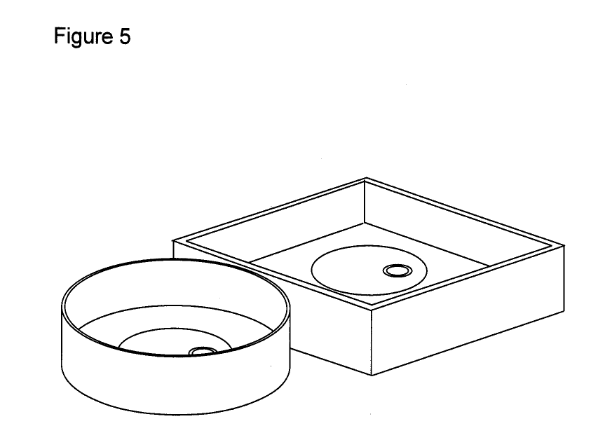

FIGS. 1-4 illustrate principal components and operations of an embodiment of the patch antenna which is optimized to operate in the North American PCS band (1850-1990 MHz). Referring in particular to FIGS. 1 and 3, the patch antenna generally comprises a radiating element 2 partially enclosed by a conductive shell 4. A back wall 6 of the shell 4 provides a ground plane for the radiating element 2, while a perimeter wall 8 of the shell 4 extends substantially perpendicular to the back wall/ground plane 6 and defines a cavity 10 in which the radiating element 2 is mounted. The radiating element 2 may conveniently be provided as a conductive (for example, metal) layer 12 defining a patch antenna affixed to a suitable dielectric substrate 14. In some embodiments, the patch antenna 12 may be provided as a copper layer disposed on a conventional printed circuit board substrate. The shell 4, can be constructed of any suitable conductive material. In some embodiments, a stamped aluminum shell may be used, although this is not essential. As may be seen in FIG. 4, the E-plane patterns of the antenna demonstrate a smooth response shape over the frequency range of interest, and the peak gain of 11 dBi, both of which are highly desirable.

Radiating Element

The design of the radiating element 2 is critical to achieving a combination of wide bandwidth and high gain. Though there are several known techniques to enhance the element bandwidth, most of them cause degradation in radiation patterns, gain and cross polarization level. In the antenna of FIGS. 1-4, the gain and bandwidth are increased by providing an air gap 16 between the substrate 14 and the ground plane 6. This helps in two ways: it increases effective thickness of the substrate 14 and also decreases the effective dielectric constant of the medium as well as surface wave loss. The decrease in the surface wave loss causes high efficiency, gain and good radiation patterns. To achieve substantial improvement in bandwidth, however, the air-gap height hd should be sufficiently large compared to the substrate thickness hₛ and this introduces a new problem, in that it increases the length of the probe 18 used to drive patch antenna 12. The longer probe length results in high probe inductance causing poor impedance matching and as such this geometry has not been widely used to enhance antenna bandwidth. With reference to FIG. 2, the antenna design is optimized for gain and bandwidth for a given substrate dielectric (e), by adjusting the patch diameter, a, the substrate height above ground hd and the overall diameter of the substrate 14.

Feed Structure

In order to realize the wide bandwidth offered by the above geometry, the large value of probe inductance must be compensated. In the illustrated embodiments, this is accomplished by providing an annular slot 20 in the patch antenna 12 surrounding the probe 18 to provide an additional capacitive loading, which nullifies the inductance of the probe 18. The air-gap 16 with slotted patch 12 improves the antenna bandwidth sufficiently to enable it to accommodate the full PCS/CELL frequencies (approx. 8% matching bandwidth). The antenna match is optimized by adjusting the parameters r, s and ρ, shown in FIG. 1.

In the illustrated embodiment, the feed probe 18 is connected to a conventional SMA connector 22, to enable connection to a conventional RF driver circuit (not shown) in a manner will known in the art.

Ground Plane

The cavity 10 defined by the perimeter wall 8 of the shell 4 serves to prevent the distortion normally produced by a small ground plane 6. In effect, the perimeter wall 8 prevents diffraction at the ground plane edge, and thereby smoothes the radiation pattern. The inside cylinder dimensions (diameter and height) can be optimized to provide a well-defined as well as large radiation aperture surrounding the radiating element 2 and to improve the antenna sidelobe radiation. The height of the cavity wall also contributes to the antenna gain and beam width.

The ground plane 6 may be provided with a threaded mounting boss 24 co-incident with the centre of the circular patch antenna 12, in order to provide a means of fastening the radiating element 2 at the desired height above the ground plane 6. If the centre of the patch antenna 12 is grounded through this boss 24, the overall antenna bandwidth may also be somewhat improved, provided the boss diameter is small, i.e. less than 2% wavelength in diameter.

While optimization of the cavity dimensions is critical to achieving optimal performance in a specific band, different cavity shapes can be used. For example, either circular (concentric with the patch antenna 12) or rectangular cavities may be used. An antenna in accordance with the embodiment of FIGS. 1-2 can be optimized for the North American PCS band utilizing a cavity diameter of 160 mm, which is just over one wavelength diameter at the centre of the band, 1.92 GHz. A cavity wall height for this antenna may be about 50 mm.

FIG. 5 shows an arrangement in which the antenna of FIG. 1 is combined with a second antenna which has, by way of example, been optimized to cover the North American cellular frequency band (824-894 MHz) In the system of FIG. 5, the cellular band antenna uses a rectangular cavity, but is otherwise closely similar to that of FIGS. 1 and 2. If desired, the two antennas may be co-located as shown to provide a compact, high performance dual band antenna package. This also illustrates another advantage of this design: because of the isolation provided by the cylinder walls, there is negligible coupling between the two antennas.

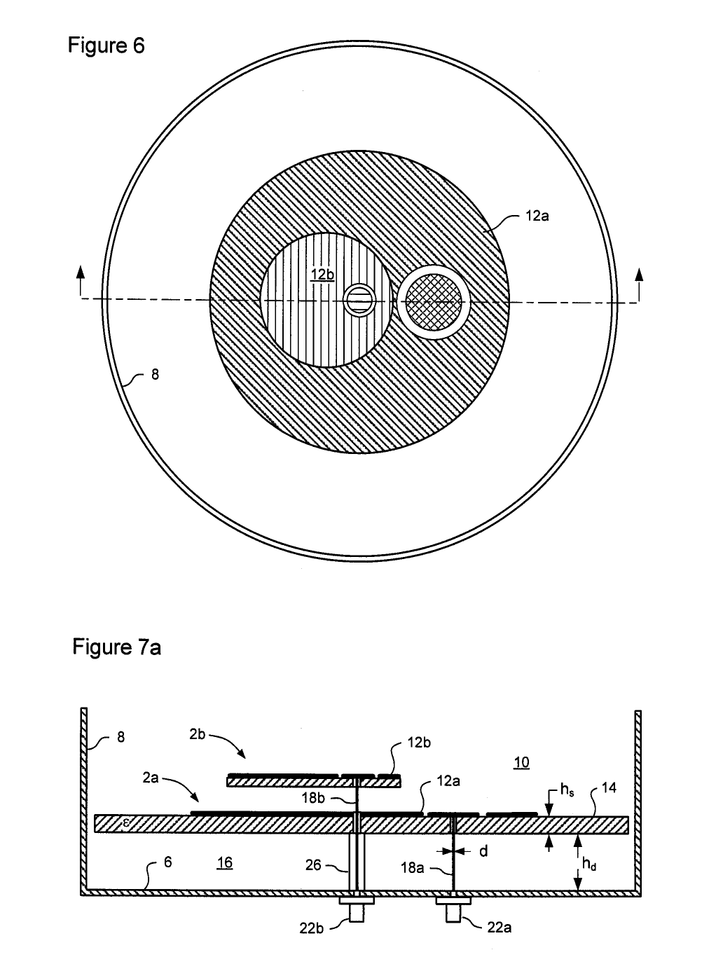

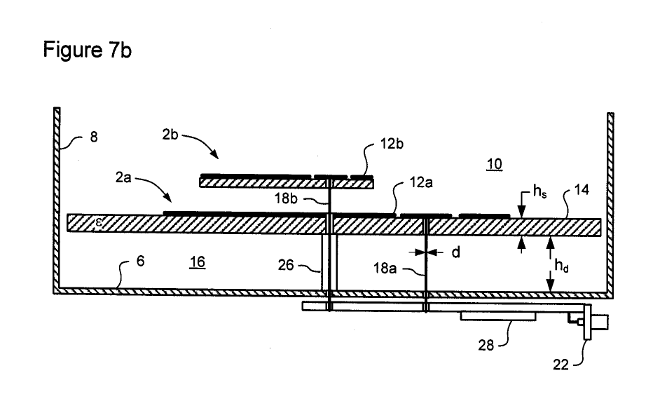

FIGS. 6 and 7a-b show an embodiment in which respective radiating elements 2a and 2b for both the cellular and PCS frequency bands are accommodated within a common cavity 10. Each radiating element 2a, 2b comprises a respective slotted patch antenna 12a, 12b driven by a probe 18a, 18b, as described above with reference to FIGS. 1 and 2. In the arrangement of FIGS. 6 and 7a-b, the radiating element 2b of the PCS band (1850-1990 MHz) is stacked above the radiating element 2a of the cellular frequency band (824-894 MHz). In the illustrated embodiment, the threaded mounting boss 24 described above with reference to FIGS. 1-4 is replaced by a coaxial transmission line 26 to feed the PCS band radiating element 2b. In this embodiment, the cellular band patch antenna 12a also serves as the ground plane element for the PCS band radiating element 2b. This eliminates the need for the PCS band radiating element 2b to have its own ground-plane, which in turn contributes to a compact high performance dual band antenna package.

In the embodiment of FIG. 7a, a respective SMA connector 22a, 22b is provided for each of the radiating elements 2a and 2b. The embodiment of FIG. 7b is closely similar to that of FIG. 7a, except that an integrated electronic Printed Circuit Board (PCB) 28 is provided. As may be appreciated, the PCB 28 can perform a variety of signal processing functions, such as, for example, amplification and/or filtering of out-of band noise.

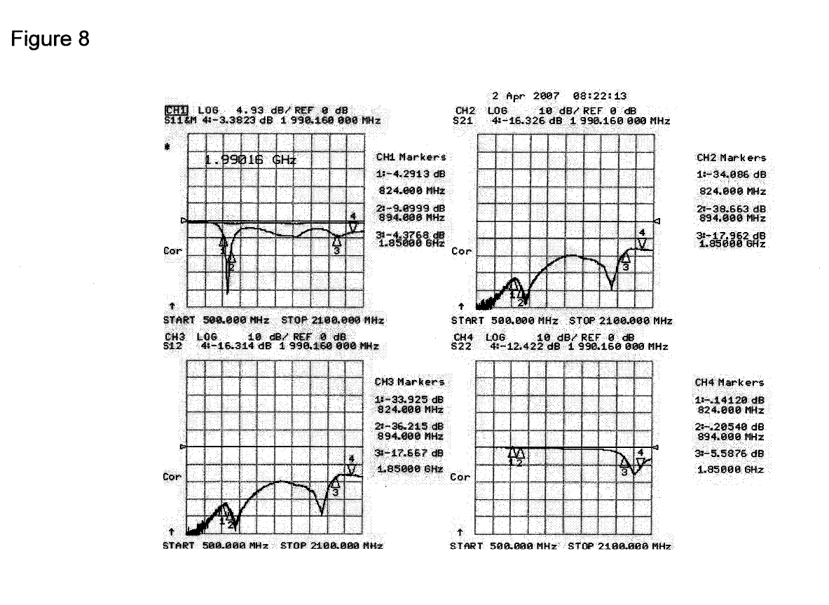

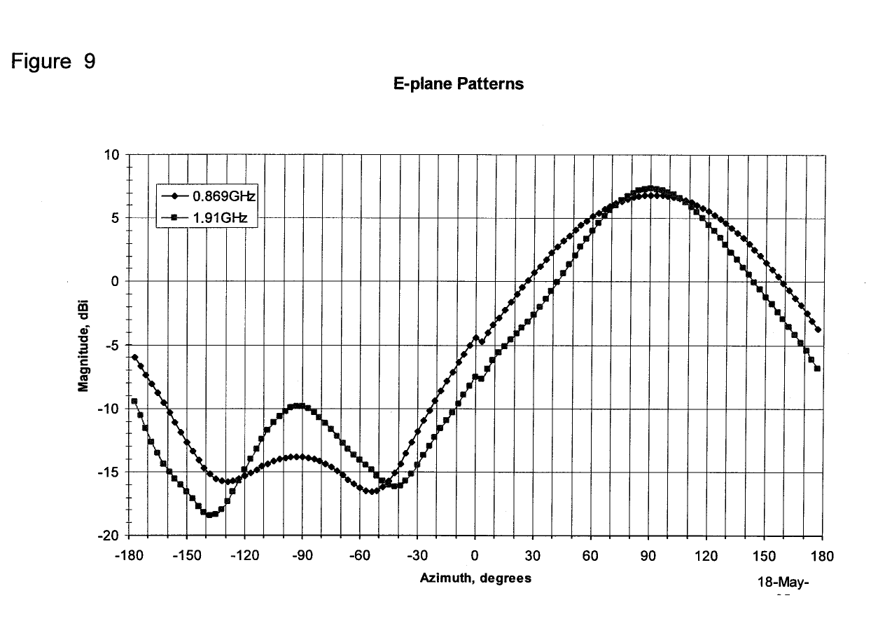

The dimension of the ground plane 6 diameter in FIGS. 6-7 is preferably selected to optimize the front to back isolation. At cellular frequencies (824-894 MHz), greater than 20 dB front to back isolation can be achieved, as may be seen in the E-Plane radiation patterns of FIG. 9. FIG. 8 shows measured return losses for this same antenna, over a frequency range of 500-2100 MHz. In these figures, points 1 and 2 indicate the upper and lower limits, respectively, of the North American cellular frequency band (824-894 MHz), while points 3 and 4 indicate the upper and lower limits, respectively, of the North American PCS band (1850-1990 MHz).

The embodiment(s) of the invention described above is(are) intended to be representative only. The scope of the invention is therefore intended to be limited solely by the scope of the appended claims.

We claim:

1. A patch antenna comprising;
a ground plane;
a wall surrounding the ground plane and electrically coupled to a perimeter thereof, the wall defining a cavity;
a radiating element disposed within the cavity substantially parallel to the ground plane and separated therefrom by a composite dielectric including an air gap;
an excitation probe electrically connected to the radiating element for exciting at least a dominant mode of the radiating element;
wherein the radiating element comprises an annular slot surrounding the excitation probe and defining a capacitive load for compensating an inductance of the excitation probe.

2. A patch antenna as claimed in claim 1, wherein a maximum dimension of the ground plane is approximately 1 wavelength of a center frequency of a desired frequency band.

3. A patch antenna as claimed in claim 1, wherein a height of the wall is less than half of a wavelength of a center frequency of a desired frequency band.

4. A patch antenna as claimed in claim 1, further comprising a mounting boss for supporting the radiating element at a desired separation distance from the ground plane.

5. A patch antenna as claimed in claim 4, wherein the mounting boss is disposed concentrically with the radiating element.

6. A patch antenna as claimed in claim 5, wherein the mounting boss is electrically connected to the ground plane and the radiating element.

7. A patch antenna as claimed in claim 1, wherein a second radiating element is disposed within the cavity and electrically connected to a respective second excitation probe for exciting at least a dominant mode of the second radiating element.

8. A patch antenna as claimed in claim 7, wherein the second radiating element is disposed substantially parallel to the first radiating element and separated therefrom by a composite dielectric including an air gap, such that the first radiating element serves as a ground plane of the second radiating element.
